(19) United States
(12) Patent Application Publication
(10) Pub. No.: US 2022/0382226 A1
(43) Pub. Date: Dec. 1, 2022

(54) DEVICE AND/OR METHOD FOR APPROXIMATE CAUSALITY-PRESERVING TIME SERIES MIXING FOR ADAPTIVE SYSTEM TRAINING

(71) Applicant: Arm Limited, Cambridge (GB)

(72) Inventors: Michael Bartling, Austin, TX (US); Brendan James Moran, Histon (GB)

(21) Appl. No.: 17/335,992

(22) Filed: Jun. 1, 2021

(51) Int. Cl. G05B 13/04; G06N 5/00; G06F 16/901

(52) U.S. Cl. CPC G05B 13/047; G06N 5/003; G06F 16/9024

(57) ABSTRACT

Subject matter disclosed herein may relate to time-series mixing for adaptive system training and may relate more particularly to causality-preserving time series mixing for adaptive system training.

### BACKGROUND

### Field

Subject matter disclosed herein may relate to time-series mixing for adaptive system training and may relate more particularly to causality-preserving time series mixing for adaptive system training.

### Information

Some electronic devices may include one or more integrated circuits, processors and/or computing devices, for example, that may comprise an adaptive system and/or device that may change structure, configuration and/or states, for example, based at least in part on parameters (e.g., signals and/or states) to flow through the system and/or device. For example, a neural network and/or the like may comprise a type of adaptive system and/or device implemented via one or more integrated circuits and/or computing devices, for example, that may change its structure (e.g., connection configuration, connection weight parameters, nodal states, etc.) based at least in part on one or more sets of input parameters to flow through the neural network during a learning phase. Depending at least in part on a particular task and/or application to be performed by an electronic device, obtaining and/or generating appropriate sets of input parameters to be utilized to train an adaptive system and/or device may pose particular challenges.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may be best understood by reference to the following detailed description if read with the accompanying drawings in which:

FIG. 1 is an illustration depicting example time series, in accordance with an implementation;

FIG. 2 depicts a flow diagram illustrating an example process for generating parameters for adaptive system training, in accordance with an implementation;

FIG. 3 is an illustration depicting an example layout for various example time series sources, in accordance with an implementation;

FIG. 4 is an illustration depicting example audio waveforms corresponding to example sources, in accordance with an implementation;

FIG. 5 depicts a diagram illustrating an example causal graph, in accordance with an implementation;

FIG. 6 depicts a flow diagram illustrating an example process for generating candidates for time series mixing, in accordance with an implementation;

FIG. 7 depicts a flow diagram illustrating an example process for generating candidates for time series mixing, in accordance with an implementation;

FIG. 8 depicts a diagram illustrating an example extended causal graph, in accordance with an implementation;

FIG. 9 is a schematic block diagram illustrating an example computing system environment, in accordance with an implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

As mentioned, some electronic devices may include one or more integrated circuits, processors and/or computing devices, for example, that may comprise an adaptive system. As utilized herein, “adaptive system” and/or the like refers to a system and/or device that may change structure, configuration and/or states, for example, based at least in part on parameters (e.g., signals and/or states) to flow through the system and/or device. For example, a neural network and/or the like may comprise an example type of adaptive system implemented via one or more integrated circuits and/or computing devices, for example, that may change its structure (e.g., connection configuration, connection weight parameters, nodal states, etc.) based at least in part on one or more sets of input parameters to flow through the neural network during a learning phase. Of course, neural networks represent merely an example type of adaptive system, and embodiments may be advantageously utilized with other machine learning and/or other artificial intelligence-type systems, for example. Depending at least in part on a particular task and/or application to be performed by an electronic device, obtaining and/or generating appropriate sets of input parameters to be utilized in training an adaptive system and/or device may pose particular challenges.

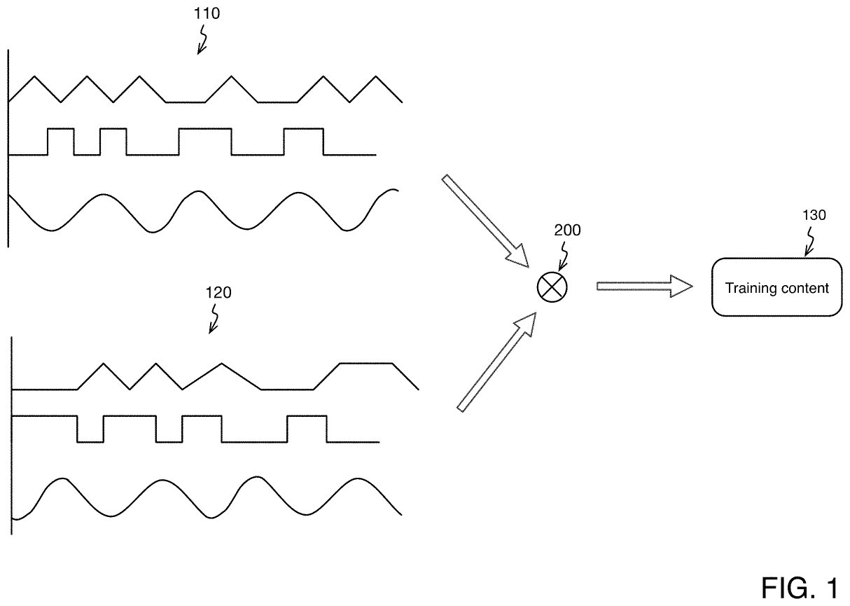

FIG. 1 is an illustration depicting example time series 110 and 120. As utilized herein, “time series” and/or “time series content” and/or the like refer to representations of particular events, states, nodes, signals, values, etc. at successive points in time. Time series content, such as generically represented in FIG. 1 as time series 110 and/or 120, may be found in a wide range of applications, disciplines, industries, etc. For example, an electrocardiogram (EKG) represents one example type of time series wherein a record of electrical signals from one's heart may be gathered over a period of time. In some situations, multiple electrical leads may be utilized to record electrical signals from one's heart at various points of one's body, for example. Doctors may examine EKG-type time series content to look for anomalies that might indicate heart disease, heart arrhythmias, etc. Seismograms from seismic monitoring stations are another example type of time series content that may be utilized to determine location, origin time and/or magnitude of seismic events (e.g., earthquakes) and/or to predict future seismic events, for example.

Another example type of time series content, such as generically represented in FIG. 1 as time series 110 and/or 120, may include computing device runtime system traces that may record representations of various aspects of computing device activity over a period of time as the computing device performs particular tasks and/or executes particular software and/or firmware, for example. Runtime system trace content may record representations of events related to, for example, a number of signals, state machines, logic circuits, execution circuits, memory locations, etc. as a computing device, for example, executes particular software and/or performs particular tasks, for example.

In some circumstances, runtime system trace content may be utilized to train adaptive systems, such as neural networks, for example, to detect and/or identify particular computing system behavior that may indicate a particular malicious attack. For example, in today's computing system environment, anomaly detection engines (e.g., adaptive systems trained to detect malicious instruction code) may rely relatively heavily on collection of runtime system trace content that represents realistic workloads and/or realistic user workflows in multi-process environments, for example, to help detect and/or identify malicious events and/or to help mitigate false positive detection rates. A particular challenge in training adaptive systems to detect and/or identify malicious and/or anomalous events, for example, may be found in generating sufficient and/or appropriate time series content representative of a very wide range of possible malicious attacks and/or anomalous events that may occur as computing devices, for example, execute a very wide range of combinations of software applications, operating systems, etc. In at least some circumstances, injecting malicious code, for example, into particular software applications, operating systems, etc. and then collecting representative runtime system trace content to generate training content for an adaptive system may prove to be extremely arduous and/or relatively unfeasible, expensive and/or inadequate.

Embodiments, such as those non-limiting examples described herein, may provide an advantageous system, device and/or process for generating time series content, such as runtime system trace content, with which to train adaptive systems, such as to detect malicious attacks and/or anomalous events. In an implementation, rather than injecting malicious payloads and/or anomalous perturbation directly into complex combinations of otherwise benign software and then subsequently gathering runtime system trace content to be used to train adaptive systems, embodiments may collect runtime system trace content for isolated instances of execution of particular software and/or firmware and also for isolated instances of execution of malicious code, for example, and may subsequently perform time series “mixing” of the collected runtime system trace content to generate training content for an adaptive system. In implementations, causal relationships between and/or among respective time series content may be maintained. For example, maintaining causal relationships and/or dependencies while mixing independently-gathered time series content to generate sets of parameters for training adaptive systems may enable use of causal reinforcement-type machine learning, in an implementation. However, subject matter is not limited in scope in this respect.

In an implementation, rather than inject a malicious payload into some portion of a particular software application (e.g., PDF viewer, web browser, etc.) and then have users interact with the particular application which may or may not lead to execution of the malicious payload, normal user interaction with the particular application may be recorded as time series content separately from the recording of time series content resulting from execution of the malicious payload. In an implementation, time series content resulting from normal user interaction with the particular application may be subsequently combined or “mixed” with time series content resulting from execution of the malicious payload to generate time series content with which to train an adaptive system to detect execution of the malicious payload, for example. As mentioned, causal relationships between and/or among respective time series content may be maintained while generating content (e.g., sets of parameters) with which to train an adaptive system.

For example, as depicted in FIG. 1, example time series 110 may represent one or more runtime system traces related to execution of a particular software application, such as a PDF viewer, for example, and/or example time series 120 may represent runtime system traces related to execution of particular malicious code. In an implementation, example time series 110 and/or 120 may be processed in accordance with a “mix” operation 200 to generate one or more sets of parameters 130 for training adaptive systems. Of course, although PDF viewers are specifically mentioned, subject matter is not limited in scope in this respect. Rather, implementations may be utilized in conjunction with any of a very wide range of software and/or firmware applications, operating systems, etc.

Further, although the discussion above is centered around computing environment security (e.g., cybersecurity) and/or runtime system traces, subject matter is not limited in scope in this respect. For example, as mentioned, EKG content may comprise an example type of time series content wherein a record of electrical signals from one's heart may be gathered over a period of time. In an implementation, example time series 110 may generically represent one or more EKG waveforms observed from one or more healthy human hearts. Further, for example, time series 120 may generically represent one or more EKG waveforms that may indicate one or more particular types of heart disease and/or arrythmias. In an implementation, it may be advantageous to train an adaptive system to detect and/or identify a particular type of heart disease and/or arrythmia. In an implementation, rather than “stitching in” time series content indicative of a particular type of heart disease and/or arrythmia into time series content representative of EKG waveforms gathered from a number of individuals in a range of circumstances in order to generate training content for an adaptive system, time series content representative of EKG waveforms from one or more individuals may be gathered separately from time series content indicative of a particular type of heart disease and/or arrythmia, making the time series gathering process much more efficient and/or much more robust. Also, in an implementation, a mixing operation, such as mixing operation 200, may be performed on the various time series content, such as time series 110 and 120, to generate training content for an adaptive system to detect and/or identify the particular type of heart disease and/or arrythmia, for example. Additional implementations may be directed at other healthcare circumstances, to seismology and/or to the financial industry, to name but a few non-limiting examples.

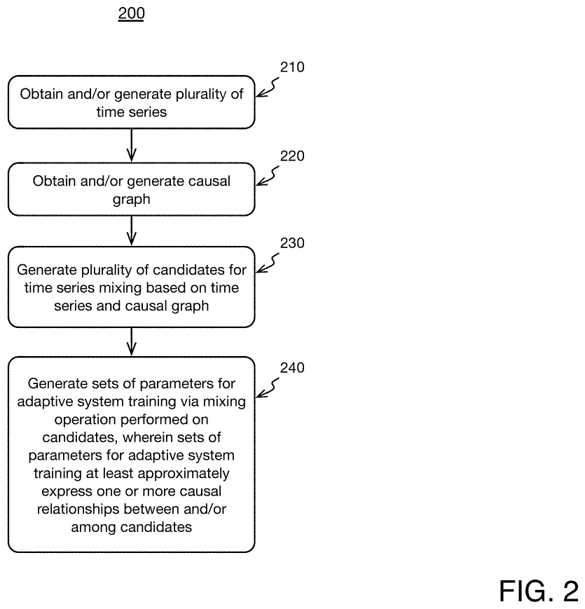

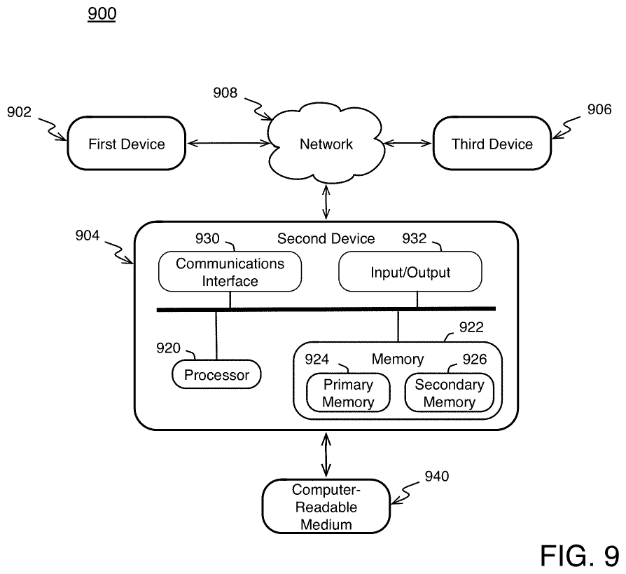

FIG. 2 depicts a flow diagram illustrating an embodiment 200 of an example process for mixing time series content to generate signals and/or states comprising sets of parameters for training adaptive systems. In an implementation, example process 200 may be performed at least in part by at least one electronic device, such as one or more of computing devices 902, 904 and/or 906 depicted in FIG. 9. However, subject matter is not limited in scope in this respect. For example, process 200 may be implemented in a particularly designed integrated circuit and/or may be implemented via configuration of one or more general purpose processing devices, in an implementation. It should be noted that content acquired or produced, such as, for example, input signals, output signals, operations, results, etc. associated with example process 200 may be represented via one or more digital signals. It should also be appreciated that even though one or more operations are illustrated or described concurrently or with respect to a certain sequence, other sequences or concurrent operations may be employed. In addition, although the description references particular aspects and/or features, one or more operations may be performed with other aspects and/or features.

As indicated at block 210 of FIG. 2, an example process for mixing time series content to generate signals and/or states comprising content for adaptive system training may include obtaining and/or generating signals and/or states representative of a plurality of sets of parameters comprising time series content. In an implementation, time series content may comprise signals and/or states representative of individual events described as discrete values in time and/or space. In an implementation, time series content may be expressed in a set-type notation.

For example, a time series Sᵢ may comprise a set of parameters {x₁, . . . , xₘ} wherein xⱼ may be represented as a tuple (tⱼ, zⱼ, mⱼ), wherein tⱼ ∈ IR⁺ (e.g., time parameter), zⱼ ∈ IR (e.g., observed value) and/or mⱼ ∈ {1, . . . , D} (e.g., dimensionality parameter), and wherein Sᵢ:={(t₁, z₁, m₁), . . . , (tₘ, zₘ, mₘ)}. In an implementation, a multiset of samples and/or parameters may be represented as a dataset D:={(S₁, y₁), . . . , (Sₙ, yₙ)}, wherein yᵢ represents a class label. Of course, subject matter is not limited in scope in these respects.

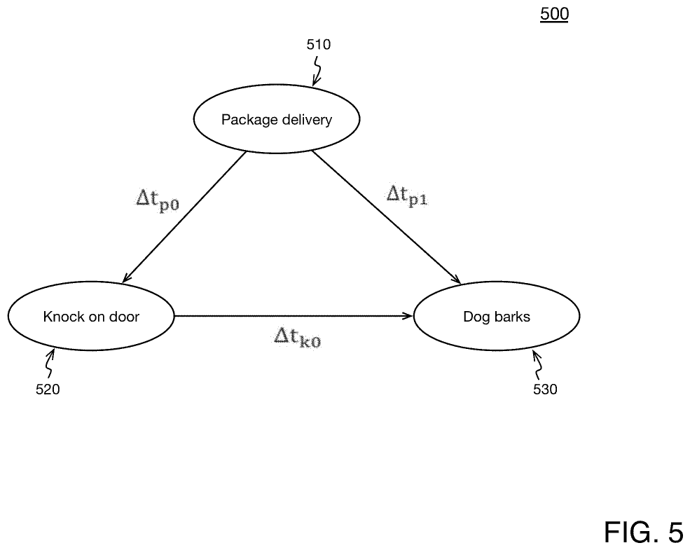

As further indicated at block 220, example process 200 may include obtaining and/or generating at the computing device signals and/or states representative of a causal graph. “Causal graph” and/or the like refers to a set of parameters representative of one or more causal dependencies and/or relationships between and/or among two or more particular time series. Causal graphs are discussed more fully below in connection with FIG. 5, for example.

In general, for particular implementations, generating time series content for training adaptive systems may include capturing time series content for individual states and/or nodes (discussed more fully below), and subsequently mixing the individual time series together based at least in part on a causal graph. In general, for particular implementations, mixing individually gathers time series content may include one or more ordered operations depending at least in part on particular characteristics of the individual time series to be combined. In an implementation, ordered operations that may be performed on time series content in order to generate time series content for training adaptive systems may include, for example, 1) superposition (e.g., addition); 2) attenuation; 3) time warping; 4) time offset; and/or 5) windowing/null case (e.g., sets window function, wⱼ, to “force” state knowledge). In an implementation, superposition and/or attenuation may simplified to a fully connected layer (e.g., element by element multiply), such as in accordance with relation 1 below.

\hat{x}[t]=αᵢ^{T}*(wᵢ(t)·*x[t]), i ∈ N (1)

Also, in an implementation, cross-channel phase shift (e.g., time offset between audio events sensed at microphones 310 and 320) may be ignored for superposition and/or attenuation operations for simplicity.

More specifically, for particular implementations, generating sets of parameters for adaptive system training may include 1) generating candidates for time series mixing; and 2) subsequent mixing of candidates to generate the sets of parameters for adaptive system training. For example, process 200 may include generating signals and/or states representative of a plurality of candidates for time series mixing based at least in part on the signals and/or states representative of the plurality of time series and based at least in part on signals and/or states representative of a causal graph, as indicated at block 230. Further, as indicated at block 240, example process 200 may also include generating signals and/or states representative of a set of parameters for adaptive system training at least in part via performing a mixing operation on the plurality of candidates for time series mixing, wherein the signals and/or states representative of the set of parameters for adaptive system training at least approximately express one or more causal relationships between and/or among the signals and/or states representative of the plurality of candidates for time series mixing. Thus, causal relationships between and/or among independently-gathered time series may be maintained as the time series are mixed to generate sets of parameters for adaptive system training.

In an implementation, a process may also include storing signals and/or states representative of the set of parameters for adaptive system training in a memory of a computing device, such as computing devices 902, 904 and/or 906, for example. Particular implementations may also include training an adaptive system at least in part by providing signals and/or states representative of a set of parameters for adaptive system training as inputs to the adaptive system, for example.

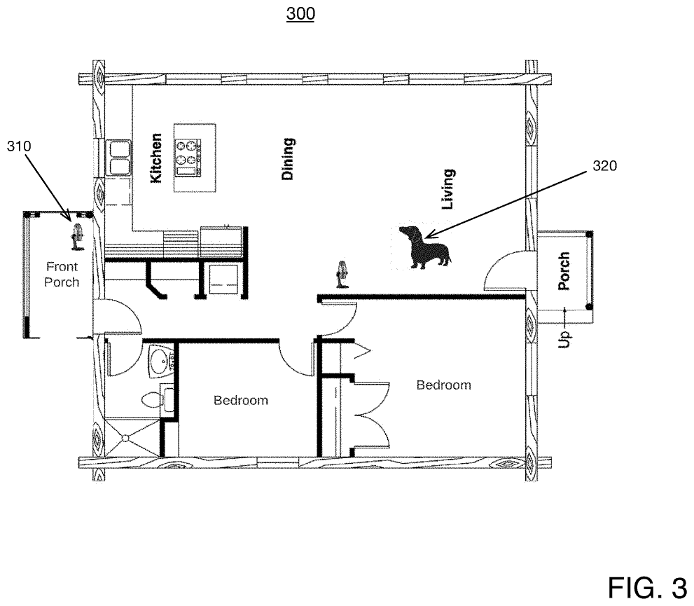

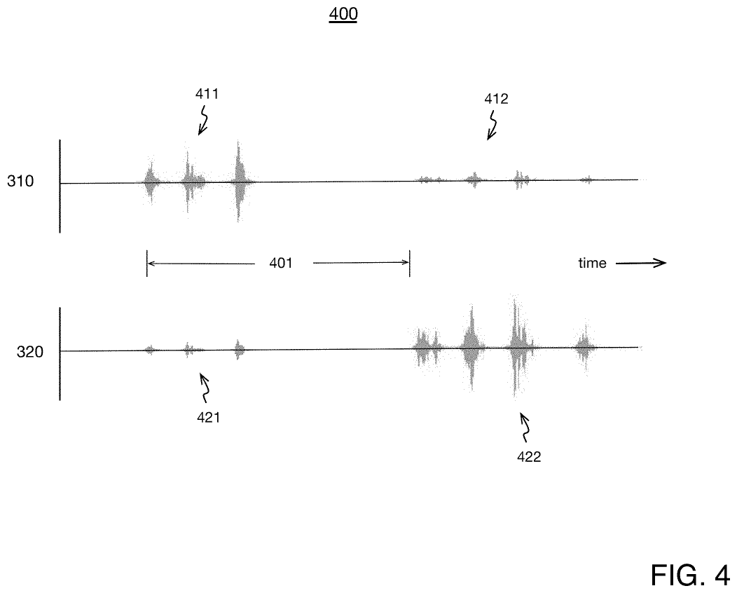

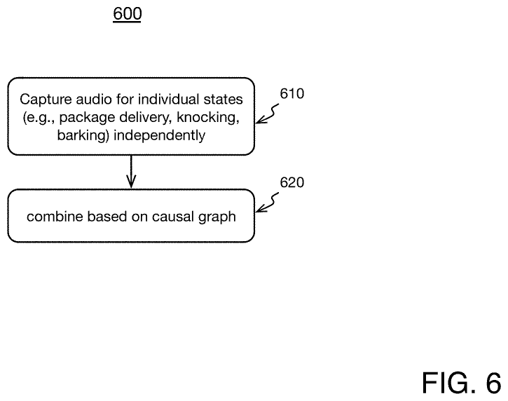

Example process 200 will be discussed in more detail below to an extent in the context of a particular “smart dog collar” example depicted in FIG. 3 through FIG. 7. As discussed more fully below, FIG. 3 is an illustration depicting an example layout 300 for various example time series sources, FIG. 4 is an illustration depicting example audio waveforms 410 and 420 corresponding to example sources and FIG. 5 depicts an example causal graph 500 pertaining to the particular example. FIG. 6 depicts a flow diagram illustrating an embodiment 600 of an example process for generating candidates for time series mixing, as also discussed more fully below.

For the particular example discussed in connection with FIG. 3 through FIG. 7, it may be deemed advantageous to design a “smart” dog collar that will beep in response to a package delivery and/or a knock on a door. A beep may be intended to warn a dog to not bark, else receive some mild, non-harmful correction (e.g., collar may deliver mild shock). Such a dog collar may be intended to solve the problem of a dog tending to bark in response to a package being dropped off and/or in response to someone knocking on the door which, for this particular simplified example, may wake a sleeping baby and/or cause some other disturbance, for example. Of course, the particular example of the smart dog collar is presented for ease and/or clarity of discussion and subject matter is not limited in scope in these respects. However, the techniques, processes, systems and/or devices discussed herein in connection with example embodiments and/or in connection with particular implementations may be applied to far more complex situations, such as generating runtime system trace content to train an adaptive system to detect and/or identify particular malicious attacks and/or other anomalous events for complex computing systems executing a wide range of possible software and/or firmware applications and/or operating systems, for example.

Turning to FIG. 3 for a moment, example layout diagram 300 shows a dog in a living room. However, for this particular example, the dog may be located anywhere within layout diagram 300. Further, although not readily visible, the dog may wear a collar that may include a microphone 320. A microphone 310 is also located at a front porch area of layout diagram 300. In some implementations, microphones may be placed in other areas of layout diagram 300, for example. However, for the present example, a two-microphone situation will be considered, wherein one microphone 310 is located at the front porch and a second microphone 320 is located on the dog collar. As mentioned, the dog is free to roam other areas of layout diagram 300. Again, subject matter is not limited in scope in these respects.

Even with a simple example such as the two-microphone situation described above, challenges may be encountered in generating training content for an adaptive system, such as a smart dog collar. Adaptive systems, such as neural networks and/or other machine learning devices, for example, may utilize diverse and/or representative time series content in order to adequately generalize intended operation. For example, to design and/or create a smart dog collar that is intended to discourage dogs from barking in response to delivery of a package and/or in response to a knock at a door, such a dog collar may need to properly operate if utilized with any of a wide variety of breeds, sizes and/or temperaments, with a wide variety of house layouts and/or with a wide variety of types of knocking sounds. It may be expensive, time consuming and/or resource consuming to gather time series content for the great many combinations of dog type, layout type and/or knocking type. For more complex circumstances, such as may be the situation for adaptive system training for cybersecurity tasks, for example, the challenges may grow exponentially. As mentioned, embodiments may address such challenges in whole or in part by gathering time series content independently for the various sources (e.g., microphone 310 and microphone 320) and subsequently combining them via a mix operation, such as example operation 200, to generate adaptive system training content.

Turning to FIG. 4, example audio waveforms 400 corresponding to microphone 310 (located at front porch) and microphone 320 (located on dog collar) are depicted. In an implementation, the audio waveforms corresponding to microphones 310 and/or 320 may be represented via respective time series. For example, a time series for microphone 310 may include a set of parameters describing magnitudes of an audio signal gathered at microphone 310 corresponding to particular, sequential points in time. For an audio waveform corresponding to microphone 310, a series of three knocks at the front door may be observed (see 411 of waveforms 400) for this particular example. For the audio waveform corresponding to microphone 320 located on the dog collar, knocks at the door may be observed a short time after the knocks recorded by microphone 310 located at the front porch (see 412 of waveforms 400). The knocks recorded at the dog collar may not only be delayed in time in relation to the knocks sensed by microphone 310 but may also be attenuated in magnitude (e.g., the sound of the knocks arrives at the dog a fraction of time later and is significantly more quiet). Further, the audio waveform corresponding to microphone 320 located on the dog collar depicts a series of barks from the dog (see 422 of waveforms 400). A short time later, the dog barks are sensed by microphone 310 (see 412 of waveforms 400) with an attenuated magnitude. In an implementation, the time delay between door knocks represented by respective audio waveforms for microphones 310 and 320 may be referred to as a “phase shift.”

In an implementation, time series mixing, such as example operation 200, may be performed such that causal relationships (e.g., temporal dependencies and/or other knowable relationships) between and/or among the different time series may be maintained, as discussed more fully below. It may be noted that simple “stitching in” of one time series into another may not maintain causal relationships, in contrast with example mixing operation 200, for example. As indicated at block 220, example operation 200 may include obtaining and/or generating a causal graph.

Referring again to FIG. 2, a causal graph may be obtained and/or generated as indicated at block 220. An example causal graph 500 is provided at FIG. 5. As utilized herein, “causal graph” and/or the like refers to a set of parameters representative of one or more causal dependencies and/or relationships between and/or among two or more particular time series. Further, causal graphs may include a number of nodes or vertices. “Node,” “vertex” and/or the like refer to signals and/or states representative of particular states and/or events, such as further discussed below, for example. Further, node, vertex and/or the like may be utilized herein interchangeably, in particular implementations. In a causal graph, “connections,” “edges” and/or the like between nodes may comprise signals and/or states (e.g., parameters, values, etc.) representative of relationships and/or dependencies, such as, for example, time delays between states.

Generally, a particular state space may be graphically described based at least in part on particular domain observations. In an implementation, such observations may be provided by a user based on a priori knowledge, although subject matter is not limited in scope in this respect. In implementations, the scientific process may be utilized to infer states and/or relations in causal graphs. For example, by experimental observation and/or by statistical analysis, it may be inferred that “A” is linked or not linked with “B,” for example. Also, causal graphs may be expanded based at least in part on experimental observation and/or statistical analysis, in an implementation. For example, a particular causal graph model may be implemented and, based at least in part on experimental observation, statistical analysis, measurements, etc., the model may be expanded until satisfactory, specified and/or advantageous results are achieved.

For the particular example of the smart dog collar, a user may observe various possible conditions and/or dependencies. For example, a package delivery driver may not knock but a dog may still bark. Also, for example, a driver might knock or a neighbor might knock. Further, the dog may not bark regardless of whether it's a driver knocking or a neighbor. We can also observe possible relationships between package delivery (node 510), knock on door (node 520) and dog barking (node 530). We can see that the dog might bark in response to a knock on the door (node 520) or in response to a package delivery (node 510). We can also see that a path between node 510 and node 530 may include node 520 (e.g., package delivery results in knock on door which results in dog barking).

A causal graph, such as causal graph 500, may capture these various relationships and/or dependencies, in an implementation. Also, in an implementation, time series mixing operations may make use of a causal graph to ensure that causal dependencies and/or relationships are maintained throughout the mixing process. As mentioned, a causal graph, such as causal graph 500, may comprise a set of parameters representative of one or more causal dependencies and/or relationships between and/or among two or more particular time series.

Again returning to FIG. 2, example process 200 may also include generating a plurality of candidates for time series mixing, as indicated at block 230. In an implementation, candidates for time series mixing may comprise signals and/or states representative of individual events described as discrete values in time and/or space, for example. FIG. 6 depicts a flow diagram illustrating an embodiment 600 of an example process for generating candidates for time series mixing. Generally, for the present example, audio for individual states (e.g., package delivery, knocking at door, dog barking) may be captured independently as depicted at block 610. In an implementation, audio for the individual states may be represented as individual sets of time series content, for example. Further, at block 620, individually captured time series content may be combined based at least in part on an appropriate causal graph, such as causal graph 500, for example.

Returning again to FIG. 5 and example causal graph 500, N sources may be assumed (e.g., N=2 microphones). Because cause comes before effect, there may be a time delay between individual states. In an implementation, causal graph parameters may be estimated a priori. In an implementation, time offset may be expressed in accordance with relation 2 below.

Δtₓ˜N(μₓ, σₓ) (2)

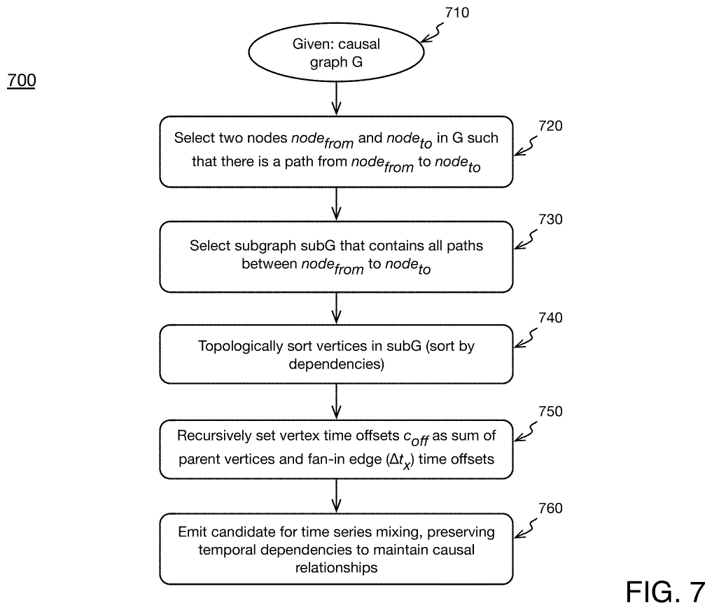

Further, in an implementation, cause/effect relationships (e.g., ordering) may be preserved across sources, else a trace may be considered to be invalid. For example, given causal graph 500, dog barking 530 may not come before package delivery. For causal graph 500, several valid paths may be observed, as explained more fully below in connection with FIG. 7.

FIG. 7 depicts a flow diagram illustrating an embodiment 700 of an example process for generating candidates for time series mixing. In an implementation, example process 700 may provide additional detail pertaining to candidate generation operations indicated at block 230 of FIG. 2, for example. It should be noted that content acquired or produced, such as, for example, input signals, output signals, operations, results, etc. associated with example process 700 may be represented via one or more digital signals. It should also be appreciated that even though one or more operations are illustrated or described concurrently or with respect to a certain sequence, other sequences or concurrent operations may be employed. In addition, although the description references particular aspects and/or features, one or more operations may be performed with other aspects and/or features.

As indicated at FIG. 7, given a causal graph G (see block 710), a number of operations 720-760 may be performed to generate candidates for time series mixing. For example, at block 720, two nodes, node_{from} and nodeₜₒ, may be selected such that there is a path from node_{from} and nodeₜₒ. For example, nodes 510 and 530 may be selected. Further, as indicated at block 730, a subgraph subG may be generated, wherein subG includes all paths between node_{from} and nodeₜₒ. For example, for nodes 510 and 530, subG may include a path from node 510 through node 520 and ending at node 530 and may also include a path directly between node 510 and node 530. Similarly, for node_{from}=node 510 and nodeₜₒ=node 520, subG may include a single path between nodes 510 and 520. For example, no valid path exists from node 510 to node 530 and then to node 520 due to the dependency relationships expressed in causal graph 500 (e.g., dog bark follows knock on door rather than preceding knock).

Additionally, in an implementation, as indicated at block 740, vertices of subgraph subG may be topographically sorted (e.g., sorted based at least in part on dependencies and/or relationships between nodes/states). Further, as indicated at block 750, vertex time offsets, c_{off}, may be recursively set as a sum of parent vertices and fan-in edge (Δtₓ) time offsets. Such an operation may be more efficiently performed if leveraging topological sorting indicated at block 740. Also, in an implementation, based on operations indicated at blocks 720 through 750, a set of parameters (subG, topo_ordering) may be emitted as a candidate for time series mixing, as indicated at block 760. In an implementation, causal dependencies and/or relationships may be maintained based at least in part on topographical sorting of block 740 and/or based at least in part on time offsets discussed in connection with block 750, for example.

Further, in an implementation, a user may provide a map function: state_label→primary source i. For individual candidates emitted at block 760, example process 700 may further include one or more operations to:

```
- load background time series into each xᵢ (e.g., white noise, 0s,
independent process, etc.)
- State_windows = [ ]
- For each node in candidate.topo_order:
  - i = source_map (node.state_label, x)
  - x_{c} = get_random_sample(dataset, replace=True, where lamba x:
x.label == node.state_label)
  - superimpose x_{c} on xᵢ at time offset node.c_{off}
  - State_windows.append ((node.state_label, node.c_{off}, x_{c}.len))
- Emit ((x, state_windows))
```

Returning once again to FIG. 2, sets of parameters for adaptive system training may be generated at least in part via a mixing operation performed on candidates for time series mixing, as indicated at block 240. In an implementation, sets of parameters for adaptive system training may at least approximately express one or more causal relationships between and/or among candidates. In an implementation, operations to mix candidates for time series mixing may include, for a situation with no or substantially no cross channel phase shift (operation in accordance with relation 3):

if x ∈ [symbol] ^{NxT}, for N sources and T time samples→\hat{x}=Ax, for A ∈ [symbol] ^{NxN} (3)

wherein A represents an attenuation matrix, in an implementation.

Further, for a situation with a fixed or substantially fixed cross channel phase shift (operation in accordance with relation 4):

if x ∈ [symbol] ^{NxT}, for N sources and T time samples→\hat{x}[t]=Ax[t−θ]+I_{N}x[t], for A ∈ [symbol] ^{NxN} s.t.a_{i,j}=0 for i=j, θ≥0 (4)

wherein I represents an identity matrix of dimension N and wherein θ represents a time reparameterization function.

Also, for a situation with functional phase shifting of cross channel contributions (in accordance with relation 5):

→\hat{x}[t]=Ax[θ_{c}(t)]+I_{N}x[t], for A ∈ [symbol] ^{NxN} s.t.a_{i,j}=0 for i=j, θ≥0 (5)

In an implementation, based at least in part on operations performed in accordance with relations 3, 4 and/or 5, a set of parameters for adaptive system training (x, state_windows) may be generated.

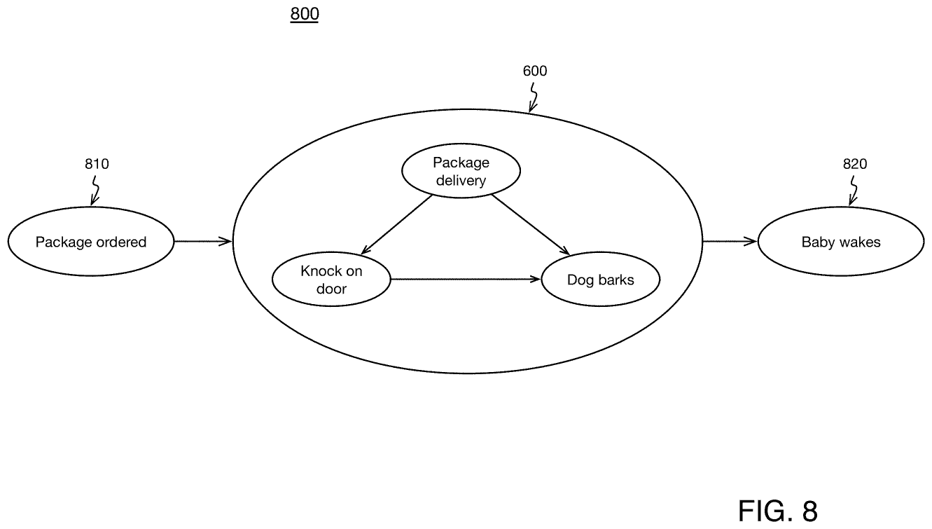

FIG. 8 depicts a diagram illustrating an example extended causal graph 800. In an implementation, the various processes and/or systems described above, for example, may be extended to more complex systems. In an implementation, any causal graph may represent an aggregate vertex (e.g., virtual node) in a higher order causal graph. For example, example causal graph 500 may be made to represent a single vertex in higher-order causal graph 800. For the present example, causal graph 800 may be expanded to include vertices/nodes representative of package ordered (see 810) and/or baby wakes (see 820). By generating hierarchical and/or inductively-generated causal graphs, more complex graphs may be formed from relatively simple building blocks.

For example, a first set of nodes may be represented as a virtual node in second set of nodes, the second set of nodes may in turn be represented as a virtual node in a third set of nodes, and so forth, until a complete causal graph is generated. In this context, “virtual node” and/or the like refers to a node that is representative of one or more other nodes. In an implementation, a causal graph may include any number of virtual nodes respectively representing any number of nodes. In this manner, causal graphs of any complexity may be inductively generated, for example. Also, as mentioned, causal graphs, such as may include one or more virtual nodes, for example, may be expanded in accordance with the scientific process based at least in part on experimental observation, statistical analysis, measurements, etc. until satisfactory, specified and/or advantageous results are achieved.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall within the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modeled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

A “signal measurement” and/or a “signal measurement vector” may be referred to respectively as a “random measurement” and/or a “random vector,” such that the term “random” may be understood in context with respect to the fields of probability, random variables and/or stochastic processes. A random vector may be generated by having measurement signal components comprising one or more random variables. Random variables may comprise signal value measurements, which may, for example, be specified in a space of outcomes. Thus, in some contexts, a probability (e.g., likelihood) may be assigned to outcomes, as often may be used in connection with approaches employing probability and/or statistics. In other contexts, a random variable may be substantially in accordance with a measurement comprising a deterministic measurement value or, perhaps, an average measurement component plus random variation about a measurement average. The terms “measurement vector,” “random vector,” and/or “vector” are used throughout this document interchangeably. In an embodiment, a random vector, or portion thereof, comprising one or more measurement vectors may uniquely be associated with a distribution of scalar numerical values, such as random scalar numerical values (e.g., signal values and/or signal sample values), for example. Thus, it is understood, of course, that a distribution of scalar numerical values, for example, without loss of generality, substantially in accordance with the foregoing description and/or later description, is related to physical measurements, and is likewise understood to exist as physical signals and/or physical signal samples.

The terms “correspond”, “reference”, “associate”, and/or similar terms relate to signals, signal samples and/or states, e.g., components of a signal measurement vector, which may be stored in memory and/or employed with operations to generate results, depending, at least in part, on the above-mentioned, signal samples and/or signal sample states. For example, a signal sample measurement vector may be stored in a memory location and further referenced wherein such a reference may be embodied and/or described as a stored relationship. A stored relationship may be employed by associating (e.g., relating) one or more memory addresses to one or more another memory addresses, for example, and may facilitate an operation, involving, at least in part, a combination of signal samples and/or states stored in memory, such as for processing by a processor and/or similar device, for example. Thus, in a particular context, “associating,” “referencing,” and/or “corresponding” may, for example, refer to an executable process of accessing memory contents of two or more memory locations, e.g., to facilitate execution of one or more operations among signal samples and/or states, wherein one or more results of the one or more operations may likewise be employed for additional processing, such as in other operations, or may be stored in the same or other memory locations, as may, for example, be directed by executable instructions. Furthermore, terms “fetching” and “reading” or “storing” and “writing” are to be understood as interchangeable terms for the respective operations, e.g., a result may be fetched (or read) from a memory location; likewise, a result may be stored in (or written to) a memory location.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present patent application, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, Md., 21050-2747), but may include other aspects, such as the Hadoop distributed file system (HDFS) (available from the Apache Software Foundation, 1901 Munsey Drive, Forrest Hill, MD, 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present patent application, use of the term “Hadoop” is intended to include versions, presently known and/or to be later developed.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communicating devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

In the context of the present patent application, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g. signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present patent application that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a public, self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present patent application, may comprise a service that organizes stored digital content, such as, for example, text, images, video, etc., through the use of hypermedia, for example. It is noted that a network, such as the Internet and/or Web, may be employed to store electronic files and/or electronic documents.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the term “Web site” and/or similar terms refer to Web pages that are associated electronically to form a particular collection thereof. Also, in the context of the present patent application, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

In the context of the present patent application, the terms “entry,” “electronic entry,” “document,” “electronic document,” “content”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such as via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, 4G, or 5G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), 802.11b/g/n, and/or the like. A wireless network may include virtually any type of now known and/or to be developed wireless communication mechanism and/or wireless communications protocol by which signals may be communicated between devices, between networks, within a network, and/or the like, including the foregoing, of course.

In one example embodiment, as shown in FIG. 9, a system embodiment may comprise a local network (e.g., device 904 and medium 940) and/or another type of network, such as a computing and/or communications network. For purposes of illustration, therefore, FIG. 9 shows an embodiment 900 of a system that may be employed to implement either type or both types of networks. Network 908 may comprise one or more network connections, links, processes, services, applications, and/or resources to facilitate and/or support communications, such as an exchange of communication signals, for example, between a computing device, such as 902, and another computing device, such as 906, which may, for example, comprise one or more client computing devices and/or one or more server computing device. By way of example, but not limitation, network 908 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 9 may comprise features, for example, of a client computing device and/or a remote/server computing device, in an embodiment. It is further noted that the term computing device, in general, whether employed as a client and/or as a server, or otherwise, refers at least to a processor and a memory connected by a communication bus. A “processor,” for example, is understood to connote a specific structure such as a central processing unit (CPU) of a computing device which may include a control unit and an execution unit. In an aspect, a processor may comprise a device that interprets and executes instructions to process input signals to provide output signals. As such, in the context of the present patent application at least, computing device and/or processor are understood to refer to sufficient structure within the meaning of 35 USC § 112 (f) so that it is specifically intended that 35 USC § 112 (f) not be implicated by use of the term “computing device,” “processor” and/or similar terms; however, if it is determined, for some reason not immediately apparent, that the foregoing understanding cannot stand and that 35 USC § 112 (f), therefore, necessarily is implicated by the use of the term “computing device,” “processor” and/or similar terms, then, it is intended,—pursuant to that statutory section, that corresponding structure, material and/or acts for performing one or more functions be understood and be interpreted to be described at least in FIGS. 1-8 and in the text associated with the foregoing figure(s) of the present patent application.

For example, a process, in accordance with an embodiment, may comprise obtaining and/or generating at a computing device signals and/or states representative of a plurality of time series, obtaining and/or generating at the computing device signals and/or states representative of a causal graph, generating, utilizing a processor of the computing device, signals and/or states representative of a plurality of candidates for time series mixing based at least in part on the signals and/or states representative of the plurality of time series and based at least in part on the signals and/or states representative of the causal graph, and generating, utilizing the processor of the computing device, signals and/or states representative of a set of parameters for adaptive system training at least in part via performing a mixing operation on the plurality of candidates for time series mixing, wherein the signals and/or states representative of the set of parameters for adaptive system training to at least approximately express one or more causal relationships between and/or among the signals and/or states representative of the plurality of candidates for time series mixing.

In an implementation, a process may further include storing the signals and/or states representative of the set of parameters for adaptive system training in a memory of the computing device. The process may also include training the adaptive system at least in part by providing the signals and/or states representative of the set of parameters for adaptive system training as inputs to the adaptive system, for example. Additionally, in an implementation, the signals and/or states representative of the causal graph may comprise signals and/or states representative at least in part of one or more dependencies between and/or among one or more state variables of at least a first time series of the plurality of time series and at least a second time series of the plurality of time series.

In an implementation, performing the mixing operation on the signals and/or states representative of the plurality of candidates for time series mixing may include determining whether one or more respective tuples of the at least the first time series and the at least the second time series are independent, and, responsive at least in part to a determination that the one or more respective tuples of the at least the first time series and the at least the second time series are independent, may further include performing a superposition operation on the one or more respective tuples of the at least the first time series and the at least the second time series.

Further, in an implementation, performing the mixing operation on the signals and/or states representative of the plurality of candidates for time series mixing may comprise time-shifting one or more parameters of the at least the first time series in relation to one or more parameters of the at least the second time series. Also, performing the mixing operation on the signals and/or states representative of the plurality of candidates for time series mixing may comprise offsetting in time the signals and/or states representative of the at least the first time series in relation to the signals and/or states representative of the at least the second time series, for example. Additionally, in an implementation, performing the mixing operation on the signals and/or states representative of the plurality of candidates for time series mixing may include determining whether a temporal attribute of a particular tuple of the at least the first time series corresponds to a specified reference point in time, determining whether a respective particular tuple of the at least the second time series comprises a null value, and, responsive at least in part to a determination that the temporal attribute of the particular tuple of the at least the first time series corresponds to the specified reference point in time and at least in part to a determination that the respective particular tuple of the at least the second time series comprises the null value, setting a temporal attribute of the respective particular tuple of the at least the second time series to the specified reference point in time. Also, for example, the signals and/or states representative at least in part of one or more dependencies between and/or among the one or more state variables of the at least the first time series and the at least the second time series may comprise signals and/or states representative of one or more parameters specifying a cause before effect relationship between and/or among at least one of the one or more state variables of the at least the first time series and at least one of the one or more state variables of the at least the second time series.

In an implementation, generating the signals and/or states representative of the plurality of candidates for time series mixing may comprise generating one or more sets of parameters representative of one or more subgraphs, wherein the one or more subgraphs respectively comprise parameters representative of one or more paths between particular nodes of a plurality of nodes of the causal graph, and, for respective subgraphs of the one or more subgraphs, may also include sorting the parameters representative of the one or more paths between the particular nodes of the plurality of nodes of the causal graph in accordance with one or more topological dependencies.

Additionally, in an implementation, obtaining and/or generating signals and/or states representative of a causal graph may comprise obtaining and/or generating signals and/or states representative of at least one virtual node representative of a plurality of nodes. Also, for example, obtaining and/or generating signals and/or states representative of at least one virtual node may include inductively generating signals and/or states representative of a plurality of virtual nodes individually representative of respective pluralities of nodes.

Referring now to FIG. 9, in an embodiment, first and third devices 902 and 906 may be capable of rendering a graphical user interface (GUI) for a network device and/or a computing device, for example, so that a user-operator may engage in system use. Device 904 may potentially serve a similar function in this illustration. Likewise, in FIG. 9, computing device 902 (‘first device’ in figure) may interface with computing device 904 (‘second device’ in figure), which may, for example, also comprise features of a client computing device and/or a remote and/or server computing device, in an embodiment. Processor (e.g., processing device) 920 and memory 922, which may comprise primary memory 924 and secondary memory 926, may communicate by way of a communication bus 915, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 904, as depicted in FIG. 9, is merely one example, and claimed subject matter is not limited in scope to this particular example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IOT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. It is noted, however, that a SIM card may also be electronic, meaning that is may simply be stored in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network, including, but not limited to, Facebook, LinkedIn, Twitter, and/or Flickr, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 9, computing device 902 may provide one or more sources of executable computer instructions in the form physical states and/or signals (e.g., stored in memory states), for example. Computing device 902 may communicate with computing device 904 by way of a network connection, such as via network 908, for example. As previously mentioned, a connection, while physical, may not necessarily be tangible. Although computing device 904 of FIG. 9 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 922 may comprise any non-transitory storage mechanism. Memory 922 may comprise, for example, primary memory 924 and secondary memory 926, additional memory circuits, mechanisms, or combinations thereof may be used. Memory 922 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 922 may be utilized to store a program of executable computer instructions. For example, processor 920 may fetch executable instructions from memory and proceed to execute the fetched instructions. Memory 922 may also comprise a memory controller for accessing device readable-medium 940 that may carry and/or make accessible digital content, which may include code, and/or instructions, for example, executable by processor 920 and/or some other device, such as a controller, as one example, capable of executing computer instructions, for example. Under direction of processor 920, a non-transitory memory, such as memory cells storing physical states (e.g., memory states), comprising, for example, a program of executable computer instructions, may be executed by processor 920 and able to generate signals to be communicated via a network, for example, as previously described. Generated signals may also be stored in memory, also previously suggested.

Memory 922 may store electronic files and/or electronic documents, such as relating to one or more users, and may also comprise a computer-readable medium that may carry and/or make accessible content, including code and/or instructions, for example, executable by processor 920 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 9, processor 920 may comprise one or more circuits, such as digital circuits, to perform at least a portion of a computing procedure and/or process. By way of example, but not limitation, processor 920 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 920 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 9 also illustrates device 904 as including a component 932 operable with input/output devices, for example, so that signals and/or states may be appropriately communicated between devices, such as device 904 and an input device and/or device 904 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method, comprising:
obtaining and/or generating at a computing device signals and/or states representative of a plurality of time series;
obtaining and/or generating at the computing device signals and/or states representative of a causal graph;
generating, utilizing a processor of the computing device, signals and/or states representative of a plurality of candidates for time series mixing based at least in part on the signals and/or states representative of the plurality of time series and based at least in part on the signals and/or states representative of the causal graph; and
generating, utilizing the processor of the computing device, signals and/or states representative of a set of parameters for adaptive system training at least in part via performing a mixing operation on the plurality of candidates for time series mixing, wherein the signals and/or states representative of the set of parameters for adaptive system training to at least approximately express one or more causal relationships between and/or among the signals and/or states representative of the plurality of candidates for time series mixing.

2. The method of claim 1, further comprising storing the signals and/or states representative of the set of parameters for adaptive system training in a memory of the computing device.

3. The method of claim 1, further comprising training the adaptive system at least in part by providing the signals and/or states representative of the set of parameters for adaptive system training as inputs to the adaptive system.

4. The method of claim 1, wherein the signals and/or states representative of the causal graph comprise signals and/or states representative at least in part of one or more dependencies between and/or among one or more state variables of at least a first time series of the plurality of time series and at least a second time series of the plurality of time series.

5. The method of claim 4, wherein the performing the mixing operation on the signals and/or states representative of the plurality of candidates for time series mixing comprises:
determining whether one or more respective tuples of the at least the first time series and the at least the second time series are independent; and
responsive at least in part to a determination that the one or more respective tuples of the at least the first time series and the at least the second time series are independent, performing a superposition operation on the one or more respective tuples of the at least the first time series and the at least the second time series.

6. The method of claim 4, wherein the performing the mixing operation on the signals and/or states representative of the plurality of candidates for time series mixing comprises time-shifting one or more parameters of the at least the first time series in relation to one or more parameters of the at least the second time series.

7. The method of claim 4, wherein the performing the mixing operation on the signals and/or states representative of the plurality of candidates for time series mixing comprises offsetting in time the signals and/or states representative of the at least the first time series in relation to the signals and/or states representative of the at least the second time series.

8. The method of claim 4, wherein the performing the mixing operation on the signals and/or states representative of the plurality of candidates for time series mixing comprises:
determining whether a temporal attribute of a particular tuple of the at least the first time series corresponds to a specified reference point in time;
determining whether a respective particular tuple of the at least the second time series comprises a null value; and
responsive at least in part to a determination that the temporal attribute of the particular tuple of the at least the first time series corresponds to the specified reference point in time and at least in part to a determination that the respective particular tuple of the at least the second time series comprises the null value, setting a temporal attribute of the respective particular tuple of the at least the second time series to the specified reference point in time.

9. The method of claim 4, wherein the signals and/or states representative at least in part of one or more dependencies between and/or among the one or more state variables of the at least the first time series and the at least the second time series comprise signals and/or states representative of one or more parameters specifying a cause before effect relationship between and/or among at least one of the one or more state variables of the at least the first time series and at least one of the one or more state variables of the at least the second time series.

10. The method of claim 1, wherein the generating the signals and/or states representative of the plurality of candidates for time series mixing comprises:
generating one or more sets of parameters representative of one or more subgraphs, wherein the one or more subgraphs respectively comprise parameters representative of one or more paths between particular nodes of a plurality of nodes of the causal graph; and
for respective subgraphs of the one or more subgraphs, sorting the parameters representative of the one or more paths between the particular nodes of the plurality of nodes of the causal graph in accordance with one or more topological dependencies.

11. The method of claim 1, wherein the obtaining and/or generating the signals and/or states representative of a causal graph comprises obtaining and/or generating signals and/or states representative of at least one virtual node representative of a plurality of nodes.

12. The method of claim 11, wherein the obtaining and/or generating the signals and/or states representative of the at least one virtual node comprises inductively generating signals and/or states representative of a plurality of virtual nodes individually representative of respective pluralities of nodes.

13. An apparatus, comprising:
at least one processor of at least one computing device to:
obtain and/or generate signals and/or states representative of a plurality of time series;
obtain and/or generate signals and/or states representative of a causal graph;
generate signals and/or states representative of a plurality of candidates for time series mixing based at least in part on the signals and/or states representative of the plurality of time series and based at least in part on the signals and/or states representative of the causal graph; and
generate signals and/or states representative of a set of parameters for adaptive system training at least in part via performance of a mix operation on the plurality of candidates for time series mixing, wherein the signals and/or states representative of the set of parameters for adaptive system training to at least approximately express one or more causal relationships between and/or among the signals and/or states representative of the plurality of candidates for time series mixing.

14. The apparatus of claim 13, wherein the at least one processor further to initiate storage of the signals and/or states representative of the set of parameters for adaptive system training in a memory of the at least one computing device.

15. The apparatus of claim 13, wherein the at least one processor further to provide the signals and/or states representative of the set of parameters for adaptive system training as inputs to the adaptive system.

16. The apparatus of claim 13, wherein the signals and/or states representative of the causal graph to comprise signals and/or states representative at least in part of one or more dependencies between and/or among one or more state variables of at least a first time series of the plurality of time series and at least a second time series of the plurality of time series.

17. The apparatus of claim 16, wherein, to perform the mix operation on the signals and/or states representative of the plurality of candidates for time series mixing, the at least one processor to:
determine whether one or more respective tuples of the at least the first time series and the at least the second time series are independent; and
responsive at least in part to a determination that the one or more respective tuples of the at least the first time series and the at least the second time series are independent, perform a superposition operation on the one or more respective tuples of the at least the first time series and the at least the second time series.

18. The apparatus of claim 16, wherein, to perform the mix operation on the signals and/or states representative of the plurality of candidates for time series mixing, the at least one processor to time-shift one or more parameters of the at least the first time series in relation to one or more parameters of the at least the second time series.

19. The apparatus of claim 16, wherein, to perform the mix operation on the signals and/or states representative of the plurality of candidates for time series mixing, the at least one processor to offset in time the signals and/or states representative of the at least the first time series in relation to the signals and/or states representative of the at least the second time series.

20. The apparatus of claim 16, wherein, to perform the mix operation on the signals and/or states representative of the plurality of candidates for time series mixing, the at least one processor to:
determine whether a temporal attribute of a particular tuple of the at least the first time series to correspond to a specified reference point in time;
determine whether a respective particular tuple of the at least the second time series to comprise a null value; and
responsive at least in part to a determination that the temporal attribute of the particular tuple of the at least the first time series to correspond to the specified reference point in time and at least in part to a determination that the respective particular tuple of the at least the second time series to comprise the null value, set a temporal attribute of the respective particular tuple of the at least the second time series to the specified reference point in time.

21. The apparatus of claim 16, wherein the signals and/or states representative at least in part of one or more dependencies between and/or among the one or more state variables of the at least the first time series and the at least the second time series to comprise signals and/or states representative of one or more parameters to specify a cause before effect relationship between and/or among at least one of the one or more state variables of the at least the first time series and at least one of the one or more state variables of the at least the second time series.

22. The apparatus of claim 13, wherein, to generate the signals and/or states representative of the plurality of candidates for time series mixing, the at least one processor to:
generate one or more sets of parameters representative of one or more subgraphs, wherein the one or more subgraphs respectively to comprise parameters representative of one or more paths between particular nodes of a plurality of nodes of the causal graph; and
for respective subgraphs of the one or more subgraphs, sort the parameters representative of the one or more paths between the particular nodes of the plurality of nodes of the causal graph in accordance with one or more topological dependencies.

23. The apparatus of claim 13, wherein, to obtain and/or generate the signals and/or states representative of a causal graph, the at least one processor to obtain and/or generate signals and/or states representative of at least one virtual node representative of a plurality of nodes.

24. The apparatus of claim 23, wherein, to obtain and/or generate the signals and/or states representative of the at least one virtual node, the at least one processor to inductively generate signals and/or states representative of a plurality of virtual nodes individually representative of respective pluralities of nodes.
